(19) United States
(12) Patent Application Publication
(10) Pub. No.: US 2005/0033656 A1
(43) Pub. Date: Feb. 10, 2005

(54) Collaboration system suitable for on-line shopping

(75) Inventors: Xiaozhou Wang, Yamato-shi (JP); Masaaki Ishibashi, Yamato-shi (JP); Kazuhiro Yabuta, Yamato-shi (JP); Orika Itoh, Yokohama-shi (JP)

Correspondence Address: David R. Irvin;IBM Corporation T81/062, PO Box 12195, Research Triangle Park, NC, 27709, US

(73) Assignee: International Business Machines Corporation, Armonk, NY (US)

(21) Appl. No.: 10/828,978

(22) Filed: Apr. 21, 2004

(30) Foreign Application Priority Data
Aug. 5, 2003 (JP) 2003-286578

(51) Int. Cl. G06F 17/30

(52) U.S. Cl. 705/26

(57) ABSTRACT

A collaboration system includes a plurality of client devices individually connected to a network, and a server apparatus for receiving requests from the client devices, responding to the client devices, and providing a common collaboration environment among the client devices. The server includes means for providing a group session formed by integrating communication sessions of the plurality of client devices, and means for synchronizing the client devices in the collaboration environment. Each of the client devices includes means for synchronizing displays on the plurality of client devices.

### FIELD OF THE INVENTION

The present invention relates to collaboration among network-connected computer devices that enables users of the computer devices to share a web page without being conscious of their physical separation.

### BACKGROUND

In recent years, the performance of computer devices and portable terminals has improved, network technology has progressed, and the accessibility of network infrastructure has been enhanced. Alongside these developments, on-line or net shopping, which includes ordering items using browser software, has become widespread, thereby enabling customers to shop without leaving home.

In on-line shopping, a customer accesses a server to interact with web pages of a catalog of some sort to select and purchase items. This may be contrasted with traditional brick-and-mortar shopping, wherein a customer often goes to a store with like-minded friends, who provide advice and give their opinions regarding items to be purchased. Thus there is a fundamental difference between on-line shopping and brick-and-mortar shopping, as customers act alone when shopping on-line.

In other words, on-line shoppers make their purchases in an environment that is significantly different from the usual purchasing environment. Even though an on-line shopper may want to ask a friend for an opinion about an item, the use of e-mail and telephone is inconvenient, insofar as an item displayed on the web page catalog cannot be shared visually with the friend.

Technology has been developed for allowing client devices to collaborate with one another on a network. For example, Japanese Laid-Open Patent No. 2001-14252 discloses a method for enabling client devices to collaborate over a network. This method allows a server to store information such as purchase histories of customers. Upon receiving an HTTP request, the server refers to the purchase history of the customer, selects an agent computer that has established collaboration in accordance with other set conditions, and embeds, into an HTTP response, a command to allow predetermined information to be displayed, thus allowing the client devices to collaborate.

Japanese Published Unexamined Patent Application No. Hei 10-124461 discloses a method for enabling two or more users to collaborate using an HTML page simultaneously on the Internet. In order to enable a plurality of client devices to share the HTML page, a predetermined client device first issues an HTTP request to a server. The client device receives an HTTP response through which a predetermined web page can be accessed. Meanwhile, the client device is provided with a web sharing manager, copies the received HTTP response, and transmits the copied HTTP response to another client device, thus enabling the client devices to share the web page.

FIG. 13 shows an example of conventional on-line shopping. A client device 100 is located on a customer site, and accesses a front-end web server 104 through a network 102 such as the Internet. A back-end server 106 for allowing a requested application to be executed is connected to the front-end web server 104. The front-end web server 104 processes the received HTTP request, passes a command obtained by such processing to the back-end server 106, enables the back-end server 106 to retrieve item and customer information stored in a database 108, and enables a requested shopping command to be executed.

Between the client device 100 and the front-end web server 104, transactions are created from responses corresponding to a variety of requests. The transactions allow a variety of web pages to be displayed to a customer in response to HTTP requests.

When there is no collaboration between client devices in an on-line shopping system, a plurality of customers enter an HTTP request to access a common URL address. In this case, each of the customers is given the right to change web pages. Accordingly, even when the customers who have entered a common HTTP request are trying to act together, the customers will be able to change web pages independently. Moreover, because the web pages cannot be synchronized with each other, the customers may have altogether different views.

These problems may be solved if web pages are shared using the collaborative technology described above. However, even if a common web page can be browsed, the conventional collaboration or sharing method for a web page does not suggest any way for allowing respective customers browsing the same web page to collaborate for processing purchase requests.

Specifically, even if a web page is shared according to the conventional web page sharing method, the right to start or end a session is given only to the customer who has first accessed the web server, and an invited customer may only browse the shared web page. Therefore, although the invited customer may browse the web page, the invited customer cannot establish a new session for purchasing items by using the displayed web page under a session belonging to the customer who first accessed the web server.

Thus there is a need to further enhance the utility of the web page in a way that makes the on-line shopping experience more like the traditional brick-and-mortar shopping experience, and to minimize the feeling of isolation that now accompanies computer collaboration.

### SUMMARY

The present invention provides a collaboration environment that enables a plurality of users to access the same web page through their browsers while communicating with each other. For convenience, the invention will be described in the context of on-line shopping, although the invention is not limited to this context.

In an illustrative virtual shopping system including the collaboration system of the present invention, the same web page can be browsed from a plurality of different terminal devices. When one customer changes the web page, this causes the other customers' browsers to follow suit.

Each client device sharing the web page access the server through its own individual session. The client devices can access an application execution unit through a dedicated URL address to engage in a group session.

With the present invention, even though a plurality of customers may simultaneously share the same shopping screen through their browsers, each of the customers may also have an independent session with the server. Accordingly, each customer may purchase independently of the others.

The mutual communications may be established among the customers by, for example, a chat session that is displayed with a web page, thus making it possible for users to shop over the Internet while communicating with each other as though they were visiting a brick-and-mortar store together. Moreover, the present invention provides for transferring the initiative of web page selection among the client devices included in the group session. Accordingly, both an inviting customer and an invited customer can acquire the initiative of browsing a web page according to their requests, thus making the users less conscious of the virtual environment.

More specifically, the present invention includes server apparatus for use in a system enabling computer devices to collaborate with one another through a network. The server apparatus comprises: a group session control unit for creating a group session by integrating a plurality of individual sessions and for passing a command to an application execution unit; and a page navigation control unit for providing a web page common to each of the individual sessions.

The server apparatus further may comprise: a synchronization control unit for notifying each of the individual session destinations that the web page is shared; and a mutual communication control unit for enabling a plurality of the individual session destinations to exchange a message. The server apparatus may include initiative switching means for switching ownership of the initiative of web page operation. The page navigation control unit may include a page sharing processing unit for creating data by compiling the web page and an identification value corresponding to the data in response to the display of a new web page, and for storing the data and the identification value in association with each other in a storage device.

The present invention also includes a client device for use in a system that enables computer devices to collaborate with one another through a network. The client device comprises: browser means for allowing the client device to display data received through the network; page navigation means for communicating, through the network, a request for changing ownership of the initiative to operate the web page displayed among a plurality of the client devices; synchronization control means for enabling the plurality of client devices to share the web page; and communication means for enabling the client device to display a message for other client devices. The synchronization control means may issue a request for making an inquiry about an identification value of previously compiled data of the web page through the network in response to ownership of the initiative of the operation of the web page.

The present invention also includes a computer-executable program for enabling a computer device to function as a server apparatus for use in a computer collaboration system. The program enables the computer device to execute: a step of forming a group session control unit for creating a group session by integrating a plurality of individual sessions and for passing a command to an application execution unit; a step of forming a page navigation control unit for providing a web page common to each of the individual sessions; a step of forming a synchronization control unit for notifying each of the individual session destinations of the shared status of the web page; and a step of forming a mutual communication control unit for allowing a plurality of the individual session destinations to exchange a message. In the present invention, the program allows the group session control unit to execute a step of switching ownership of the initiative of web page operation. The program allows the page navigation control unit to execute a step of creating data by compiling the web page and an identification value corresponding to the data when a new web page is displayed and of storing the data and the identification value in association with each other in a storage device.

The present invention further includes a computer-executable program for enabling a computer device to function as a client device for use in a network computer collaboration system. The program enables the computer to execute: a step of communicating a request for changing ownership of the initiative of operation of the web page to be displayed among a plurality of the client devices; a step of allowing the plurality of client devices to share the web page; and a step of allowing the client device to display a message for other client devices.

The present invention also includes a collaboration system for enabling client devices to collaborate with one another through a network. The system comprises: a plurality of client devices individually connected to the network; and a server apparatus for receiving requests from the client devices, responding to the client devices, and providing a collaboration environment common to the plurality of client devices. The server apparatus comprises: means for providing a group session formed by integrating communication sessions among the plurality of client devices; and means for synchronizing the client devices in the collaboration environment. Each of the client devices includes means for displaying the synchronization status among the plurality of client devices. In a preferred embodiment, the collaboration system of the present invention is suitable for use as a virtual shopping system.

### BRIEF DESCRIPTION OF THE DRAWINGS

For a more complete understanding of the present invention and the advantages thereof, reference is now made to the following description taken in conjunction with the accompanying drawings.

FIG. 1 is a block diagram showing an exemplary configuration of a collaboration system according to the present invention.

FIG. 2 is a block diagram showing a client device and server apparatus.

FIG. 3 is a timing diagram for a process wherein the client devices and the server apparatus establish a group session.

FIGS. 4A and 4B are tables showing illustrative embodiments of an SSID table and an SSID sequence table, respectively, which are created by the processing of the server.

FIG. 5 is a flowchart showing processing executed by the server apparatus for allowing the client devices to share a web page after a plurality of sessions are established.

FIG. 6 is a flowchart showing processing executed by a page navigation control unit.

FIG. 7 shows an embodiment of an exemplary page management table.

FIG. 8 is a flowchart showing processing executed by a CSS of the server apparatus of the present invention.

FIG. 9 is a flowchart showing processing executed by synchronization control means in the client device.

FIG. 10 is a view showing collaboration processing between the synchronization control means and the CSS described with reference to FIGS. 8 and 9.

FIG. 11 is a view schematically explaining a function of an RTC 44 configured in the server apparatus in the present invention.

FIG. 12 is a flowchart showing processing executed by the server apparatus and the client device, which are connected through a network, for realizing a virtual shopping system.

FIG. 13 is a view showing an example of conventional on-line shopping.

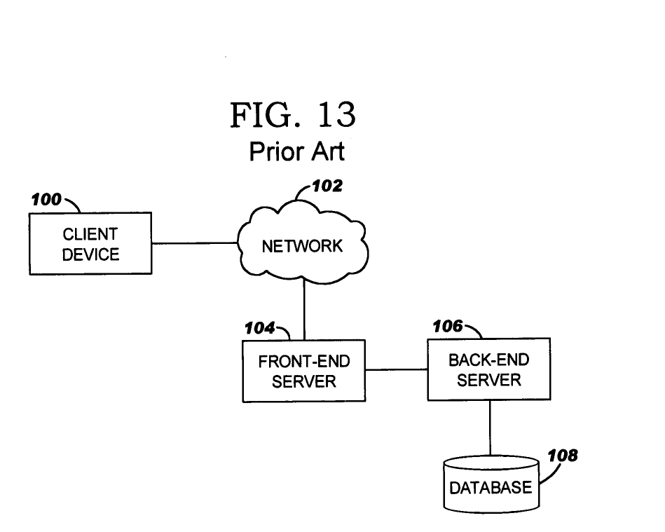

### DETAILED DESCRIPTION

The present invention will be described below in more detail with reference to the drawings. However, the present invention is not limited in its scope to the embodiments illustrated by the drawings.

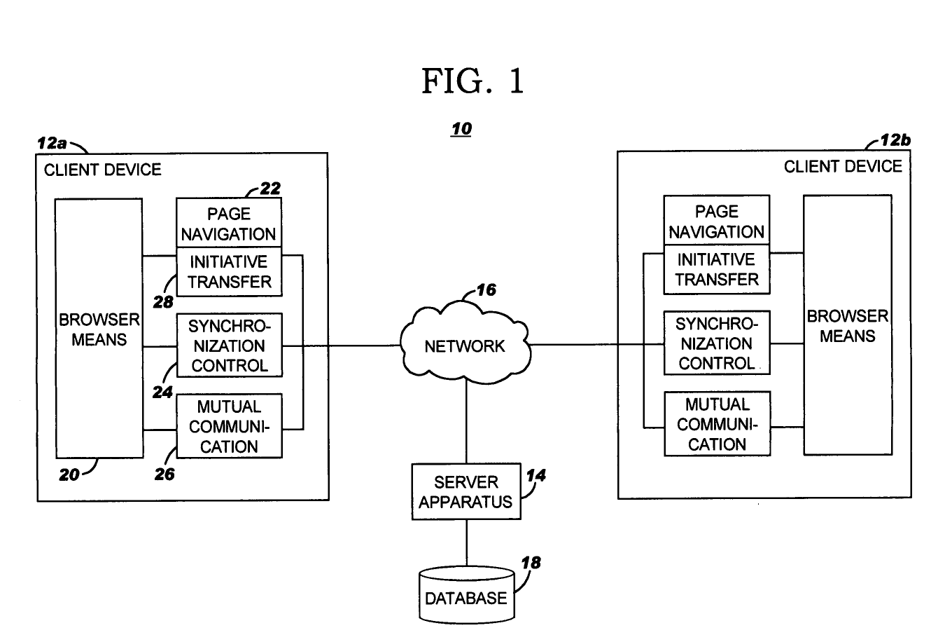

FIG. 1 is a block diagram that illustrates a virtual shopping system with collaboration among a plurality of client devices. The virtual shopping system 10 includes a plurality of client devices 12a and 12b, a server apparatus 14, and a network 16 such as the Internet, which interconnects the server apparatus 14 and the client devices 12a and 12b. Each of the client devices 12a and 12b may include browser means such as Internet Explorer (registered trademark) or Netscape Navigator (registered trademark). Each of the client devices 12a and 12b acquires a web page stored by the server apparatus 14 in a database 18. The acquired web page is displayed on a display unit included in each client device. The server apparatus 14 receives HTTP requests from the client devices 12a and 12b, identifies the client devices by the use of cookies or the like, retrieves applicable web pages based on commands included in the HTTP requests, and sends, as HTTP responses, data for displaying the web pages as, for example, HTML documents, to the predetermined client devices, thus servicing the HTTP requests.

Upon receiving a notice from the client device 12a to invite the client device 12b, the server apparatus 14 creates a group session, and passes snapshot data of a web page then browsed by the client device 12a to the client device 12b, thus enabling the client devices 12a and 12b to browse the same web page.

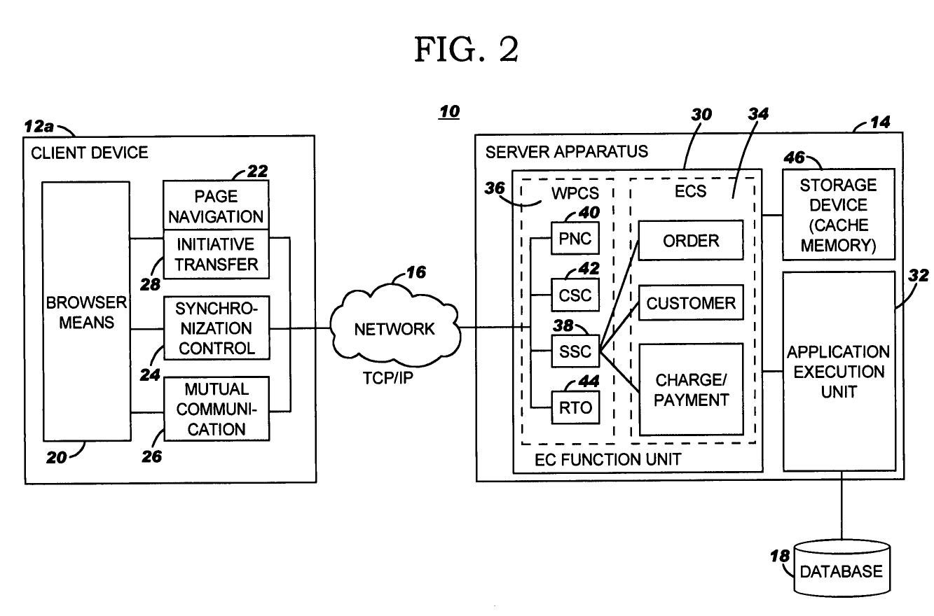

FIG. 2 is a block diagram that illustrates the structure of the client device 12a and the server apparatus 14. As shown in FIG. 2, the client device 12a and the server apparatus 14 communicate through the network 16 using a protocol such as TCP/IP. The client device 12a includes browser means 20, page navigation means 22, synchronization control means 24, and mutual communication means 26. The page navigation means 22 includes initiative transfer means 28, and allows the client device 12a to access the server apparatus 14 directly and to acquire a web page when the client device 12a has ownership of the initiative of web page operation. In response to an instruction from a customer, the initiative transfer means 28 transmits, to the server apparatus 14, an HTTP request to transfer ownership of the initiative, and allows the server apparatus 14 to transfer ownership of the initiative of the web page operation to another client device. Immediately thereafter, snapshot data of the web page changed by the other client device is transmitted from the server apparatus 14 to the client device which has lost the initiative, thus making it possible to share the web page.

The server apparatus 14 may include an E-Commerce function unit (hereinafter, referred to as an EC function unit) 30 and an application execution unit 32. The EC function unit 30 includes an E-Commerce subsystem (ECS) 34 and a web page collaboration system (WPCS) 36. The ECS 34 may include a plurality of subsystems such as an order subsystem, a member subsystem, and a charge/payment subsystem. The ECS 34 authenticates the customer and determines its privileges, receives an order from the customer, and enables the server apparatus 14 to execute a verification of the charge/payment. The WPCS 36 includes a shopping session control unit (SSC) 38, a page navigation control unit (PNC) 40, a client synchronization control unit (CSC) 42 for enabling synchronization between the client devices, and a mutual communication control unit (RTC) 44. A storage device 46 such as a cache memory is connected to the EC function unit 30, and stores data required for group sessions formed as the need arises.

The SSC 38 enables the plurality of client devices sharing the web page to establish unique individual sessions (described below) among themselves. When the web page is changed by a customer, the PNC 40 executes the following processing to display the web page on the client devices of the other customers. First, the PNC 40 creates snapshot data by compiling a plurality of files for configuring the web page and creates an identification value for designating the snapshot data uniquely. Subsequently, the PNC 40 stores the snapshot data and the identification value in the server apparatus 14 in association with each other. The CSC 42 gives the web page or the snapshot data to the client devices among which the web page is to be shared, so that the same web page is displayed synchronously on the plurality of different client devices. Further, the RTC 44 may provide a chat function that enables real-time communication among the customers using the client devices sharing the web page.

The page navigation means 22, synchronization control means 24, and mutual communication means 26 of the client device 12a individually receive information from the respective control units included in the WPCS 36 of the server apparatus 14, extract an applicable URL address and a command from the received HTTP response, and allow the address and the command to be displayed on the client devices by use of the browser means 20. The client device 12a may be enabled to perform a shopping operation desired by the customer in response to the HTTP response from the server apparatus 14. In the present invention, the above-described page navigation means 22, synchronization control means 24, and mutual communication means 26 can be realized by executing programs described in a language such as, for example, Java, Java Applet, Java Beans, or Java Script.

In one embodiment, programs for executing the above-described functions may be included as part of the browser means 20. Alternatively, in other embodiments of the present invention, the programs may be downloaded by the server apparatus 14 as HTML files, for example, to the client device 12 in response to a request from a customer.

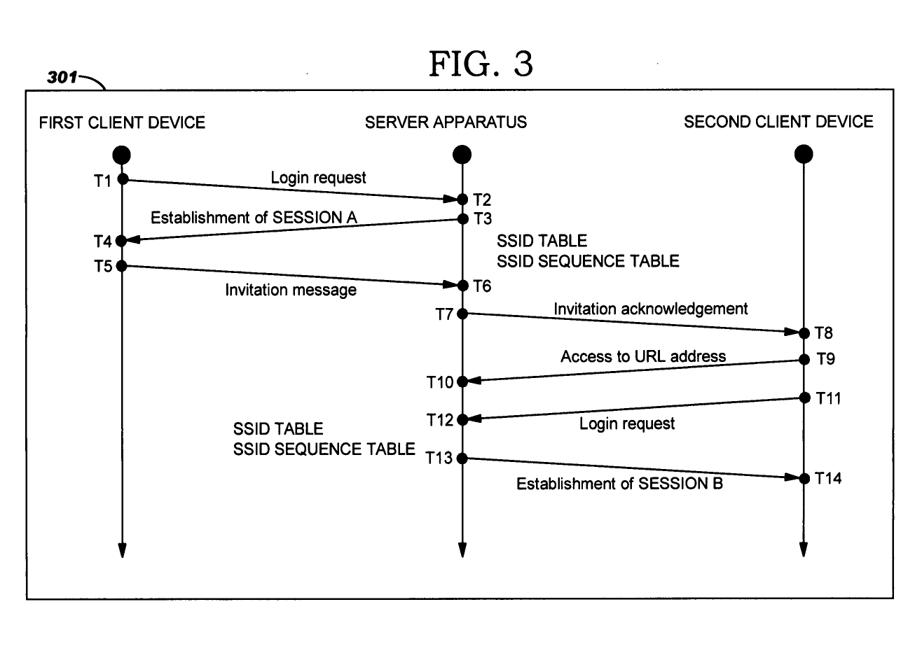

FIG. 3 shows a timing chart 301 which illustrates the case wherein the client devices and a server apparatus establish a group session. Here, the term “group session” means a session which enables client devices included in a group designated by a fixed identification value to access a common application service. In a virtual shopping system, this group session may be referred to as a shopping session.

As shown in FIG. 3, at T1, a customer connects to the server apparatus from a first client device. The server apparatus sets up an individual session with the first client device with an identification value SESSION A at T2. The server apparatus transmits an HTTP response to the first client at T3, establishes a session therewith (T4), and stores values of the SESSION A as an SSID table (described below) in an appropriate storage device. At T4, the first client device transmits a message inviting the other client devices to the shopping session, for example the message “Add Others” and a message such as “Invitee” including data designating a person to be invited. At T6, the server apparatus receives a request including the messages of “Add Others” and “Invitee.”

At T7, the server apparatus transmits an invitation notice and a URL address to be used, such as “Invitation Acknowledgment, myURL address,” to a second client device by way of, for example. The description that follows assumes that the customer using the second client device has previously received notice from the customer using the first client device and is on standby for receiving an HTML message including “Invitation acknowledgment, myURL address” or the like as electronic mail.

Upon receiving the electronic mail including the “Invitation acknowledgment, myURL address” at T8, the second client device accesses the designated URL address at T9. Subsequently, the server apparatus receives an access notice at T10, and then receives a login request from the second client at T12. Upon receiving the login request at T12, the server apparatus transmits an HTTP response at T13 to the second client device and establishes an individual session therewith using an identification value SESSION B. The server apparatus 14 creates, before T13, identification values for integrating a plurality of individual sessions, for example an SSID and a dedicated URL address responding thereto. The created SSID is stored as the SSID table together with the individual sessions and the dedicated URL address. Further, the server apparatus 14 analyzes the login request and cookie, acquires a client identification value such as an IP address of the second client device, creates an SSID sequence table (described below), and stores the SSID sequence table in the appropriate storage device. At T14, the server apparatus completes the establishment of the group session.

In a preferred embodiment of the present invention, the server apparatus sends, to the second client device, a message such as “A virtual machine must be installed for this service. Do you want to install the virtual machine?” In this way, the second client device can be allowed to acquire a program such as a Java Applet for realizing the function described with reference to FIG. 2. In other embodiments of the present invention, in the case where browser software including the browsing function of the present invention is already included in the client devices, and in the case where the browsing system of the present invention is already included in the second client device, it is not necessary for the server to transmit the Java Applet.

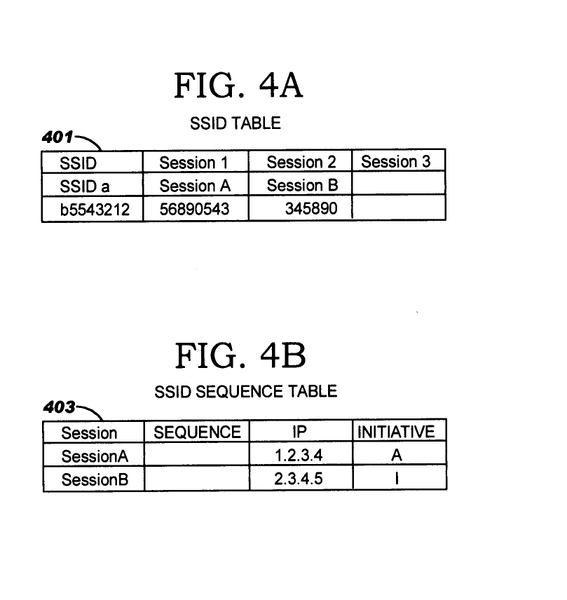

FIGS. 4A and 4B show illustrative embodiments of the SSID table 401 and SSID sequence table 403, which are created by the processing of the SSC 38 of the server apparatus, as described above with reference to FIG. 3. FIG. 4A shows an embodiment of the SSID table 401, and FIG. 4B shows an embodiment of the SSID sequence table 403. The SSID table shown in FIG. 4A can be configured as, for example, a hash table. The group session identification value SSID enabling collaborative on-line shopping and the individual session identifiers are configured as records associated with the client devices. In the SSID table shown in FIG. 4A, the records can be registered for each of different SSIDs, or different SSID tables can be configured.

FIG. 4B shows an embodiment of the SSID sequence table 403. An SSID sequence table may be configured as a hash table similarly to the SSID table. The SSID sequence table may include individual session identification values of the established individual sessions, sequence identification values indicating establishment sequences of the individual sessions, and client identification values such as IP addresses of the client devices on the other side which have established the individual sessions. The SSID sequence table mutually associates a precedent session with a client device which has established the precedent session, where the association is made using the individual session identification value and the sequence identification value. Thus, the SSID sequence table may be used to identify the client device which has started the group session based on the sequence of the individual sessions, and for controlling ownership of the initiative of web page operation by use of the identification information, for example with an initiative flag.

The request for transferring ownership of the initiative is transmitted from the client device to the server apparatus. The server apparatus which has received the request for transferring ownership of the initiative executes predetermined authentication processing in the SSC 38, and then changes an initiative flag of the client device in the applicable individual session with reference to the SSID sequence table. Thereafter, the SSC 38 notifies the PNC 40 of the transfer of ownership of the initiative, and executes processing to change the transmission destination of the data for providing the web page and the snapshot data.

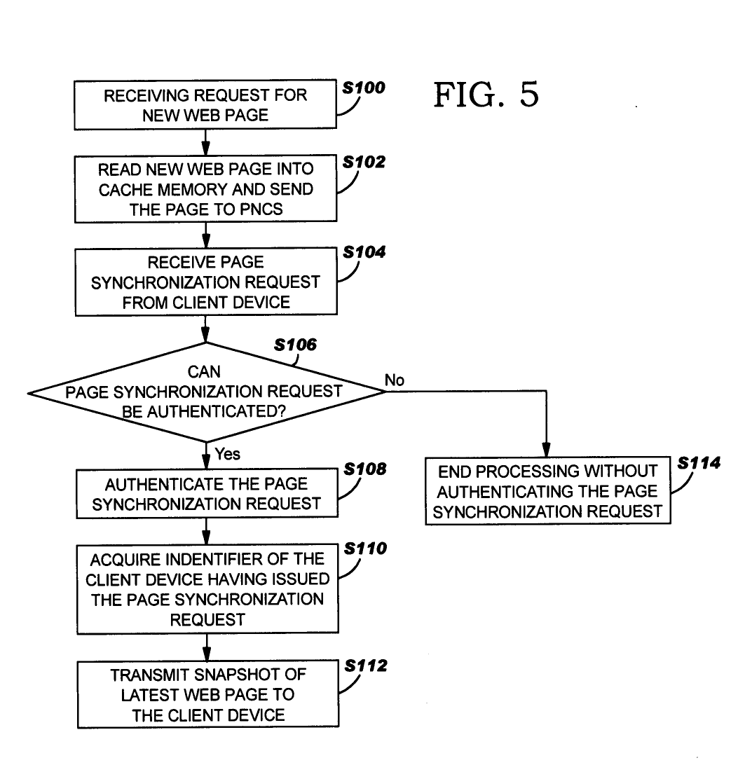

FIG. 5 is a flowchart that shows the processing of the server apparatus that allows the client devices to share the web page after the plurality of sessions are established. In Step S100, the server apparatus receives a request for a new web page from the first client device. In Step S102, the server apparatus reads the new web page into the cache memory, sends the web page data to the PNC 40, and allows the PNC 40 to use the data for processing the web page. In Step S104, the server apparatus receives, from the second client device, a page synchronization request commanding the page to be synchronized with a request from the first client device, for example, “page synchro request.” The session identification value SESSION B is included in the “page synchro request,” and is configured to specify the session and a subordinate-superior relationships among the sessions.

In Step S106, the server apparatus searches the SSID table 401, and determines whether or not the acquired session identification value SESSION B is included in the SSID table. When the acquired session identification value is found in the SSID table, the processing proceeds to Step S108, where the server apparatus authenticates the page synchronization request. Otherwise, i.e., when the acquired session identification value is not found in the SSID table, the server apparatus determines that the accesses has no rights, and the processing proceeds to Step S114, where it ends. After the page synchronization request is authenticated in Step S108, the server apparatus allows the PNC 40 to refer to the SSID sequence table in Step S110, and acquires a client identification value associated with the individual session identification value SESSION B. Thereafter, in Step S112, the server apparatus activates the CSC 42, and transmits the data of the web page to the attention of the acquired client identification value. Thus, the above-described processing of the server enables synchronous acquisition of the web page.

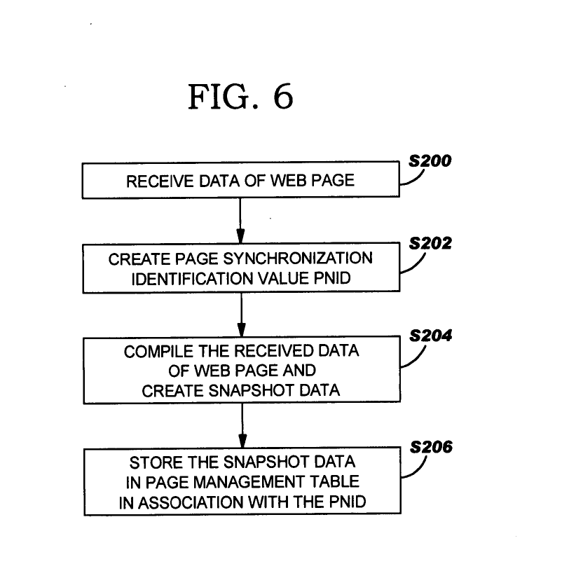

FIG. 6 is a flowchart that shows processing executed by the PNC 40. Upon receiving the HTTP request including the web page request from the client device which owns the initiative, the server apparatus 14 first transmits an HTML file for displaying the web page to the client device which owns the initiative. The PNC 40 receives the transmitted data of the web page in Step S200, and creates a page synchronization identification value PNID in Step S202. Thereafter, in Step S204, the PNC 40 compiles the received data of the web page, and creates the snapshot data. In Step S206, together with the dedicated URL address of the web page, the snapshot data is stored in a page management table created in the appropriate storage device in association with the previously created page synchronization value PNID.

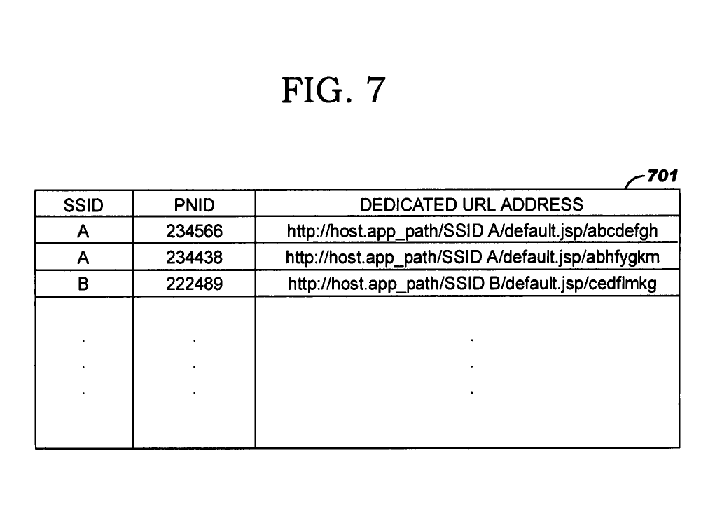

FIG. 7 shows an illustrative embodiment of the page management table 701. As shown in FIG. 7, in the page management table 701, SSIDs included in the same shopping session, PNIDs, a client identification value of the client device which owns the page initiative acquired by being given the latest PNID, and the dedicated URL address unique to the SSID of the snapshot data, together form the records in the case of the virtual shopping system. When the server apparatus 14 receives the page synchronization request from the second client device and authenticates the page synchronization request, the PNC 40 acquires the PNID most recently registered at this point in time, and allows the second client device to acquire corresponding snapshot data.

The client synchronization of the present invention is generally realized by the functions of the synchronization control means of the client devices and CSC 42 configured in the server apparatus. Individual descriptions follow below for the CSC 42 in the server apparatus and the synchronization control means in the client devices.

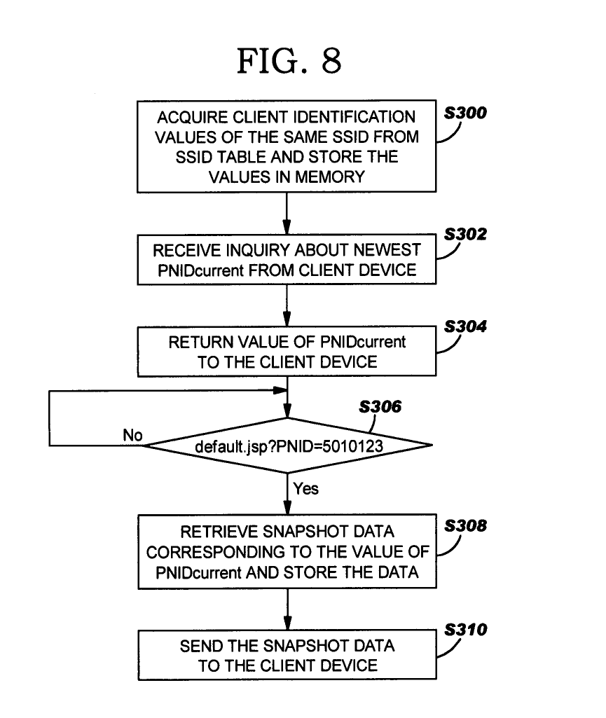

FIG. 8 is a flowchart that shows processing executed by the CSC 42 of the server apparatus. In Step S300, the CSC 42 refers to the SSID table created by the SSC 38, acquires the client identification values of the client devices participating in the shopping session, and stores the acquired values in an appropriate storage device such as a memory. In Step S302, the CSC 42 receives an HTTP request from the client device for sending PNIDcurrent, which is the most recent PNID. In Step S304, the CSC 42 returns the value of the PNIDcurrent to the client device, and is on standby for a snapshot data request. In Step S306, when the CSC 42 receives the snapshot data request from the client device, the CSC 42 retrieves the snapshot data corresponding to the PNIDcurrent, and stores the retrieved snapshot data in a buffer memory or the like in Step S308. In Step S310, the CSC 42 sends the retrieved snapshot data to the client device which has transmitted the HTTP request. Otherwise, i.e., when the CSC 42 does not receive the snapshot data request in Step S306, the CSC 42 is on standby until receiving the request.

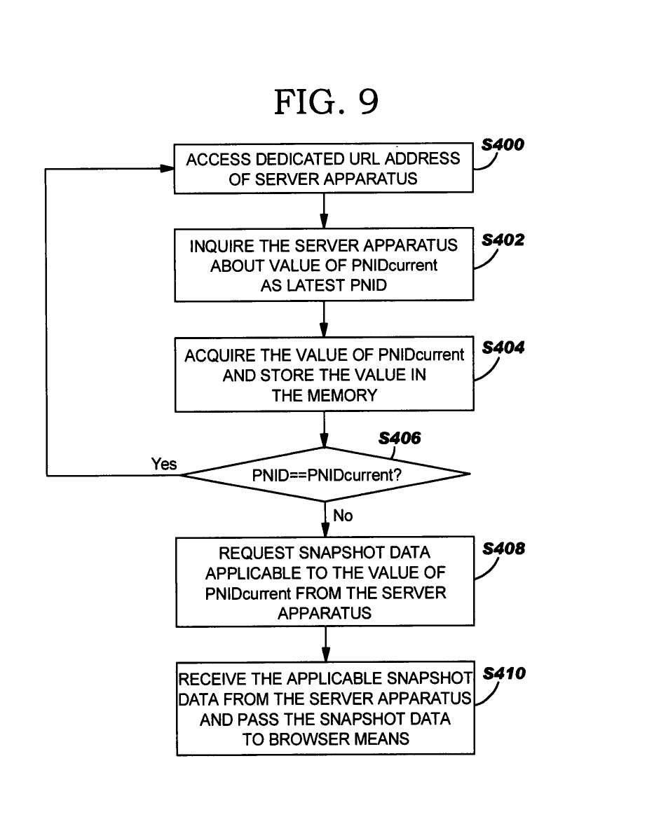

FIG. 9 is a flowchart that shows processing executed by the synchronization control means 24 configured in the client device allowed to execute the client synchronization control, using, for example, a Java Applet. In Step S400, the synchronization control means 24 accesses the dedicated URL address. Various methods can be used. For example, when the client device accesses the URL address by means of a session identifier, for example SESSION A, the server may refer to the SSID table, and allow the client device to link with and access the dedicated URL address provided uniquely to the SSID. In another embodiment of the present invention, the server apparatus may transmit the concerned SSID to the client device at the step where the SSID is created, and thus the client device can directly access the dedicated URL address.

Subsequently, in Step S402, the synchronization control means 24 transmits an HTTP request “http://host/apppath/SSID_{—}501/defaultjsp?PNID=recent” to the server, and refers to the page management tables created corresponding to the dedicated URL address. In Step S404, the synchronization control means 24 acquires the latest PNIDcurrent, and in Step S406, compares the value of the acquired PNIDcurrent with the value of the PNID owned by the client device at this point in time. When the values are equal, the processing returns to Step S400, to monitor for a web page update. Otherwise, i.e., when the value of the PNID is not equal to the value of the PNIDcurrent, the processing proceeds to Step S408, where the synchronization control means 24 acquires the value of the applicable PNIDcurrent, and transmits an HTTP request commanding the server apparatus to acquire corresponding snapshot data, for example, http://host_path/SSID_{—}501/default.jsp?PNID=5010123. In Step S410, the synchronization control means 24 acquires the snapshot data corresponding to the PNIDcurrent from the server apparatus 14, passes the data to the browser means 20, and allows the data to be displayed on the display screen of the display unit. Note that the snapshot data may be an HTML file, an XML file, or an SGML file, all of which may have already been compiled by linking text, hypertext, image data and the like together.

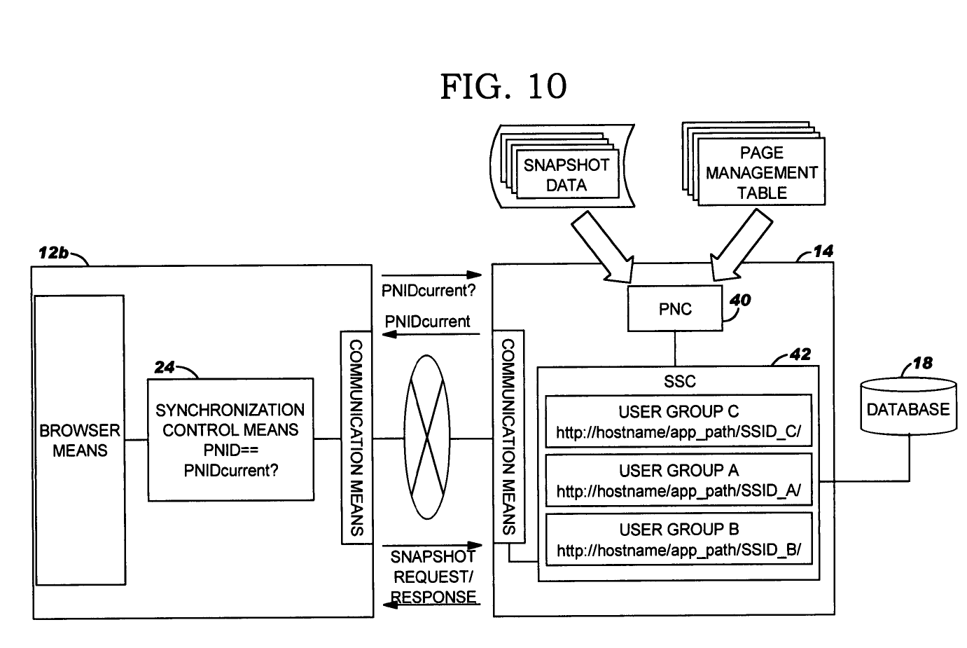

FIG. 10 shows collaboration processing between the CSC 42 and the synchronization control means 24, described with reference to FIGS. 8 and 9. As shown in FIG. 10, the server apparatus 14 allows the SSC 38 to manage the dedicated URL addresses defined for the SSIDs. The client device 12b is allowed to acquire, or is notified, of the recent PNIDcurrent by the synchronization control means 24. The synchronization control means 24 stores the PNID of the snapshot data already acquired. When the PNIDcurrent acquired from the server apparatus 14 is different from the PNID owned by the client device, the client device accesses the PNC 40 of the server apparatus, and downloads the snapshot data corresponding to the PNIDcurrent. The downloaded snapshot data (HTML file already compiled) is sent to the browser means 20 of the client device and displayed on the screen of the display unit of the client device 12b, which enables the web page to be shared.

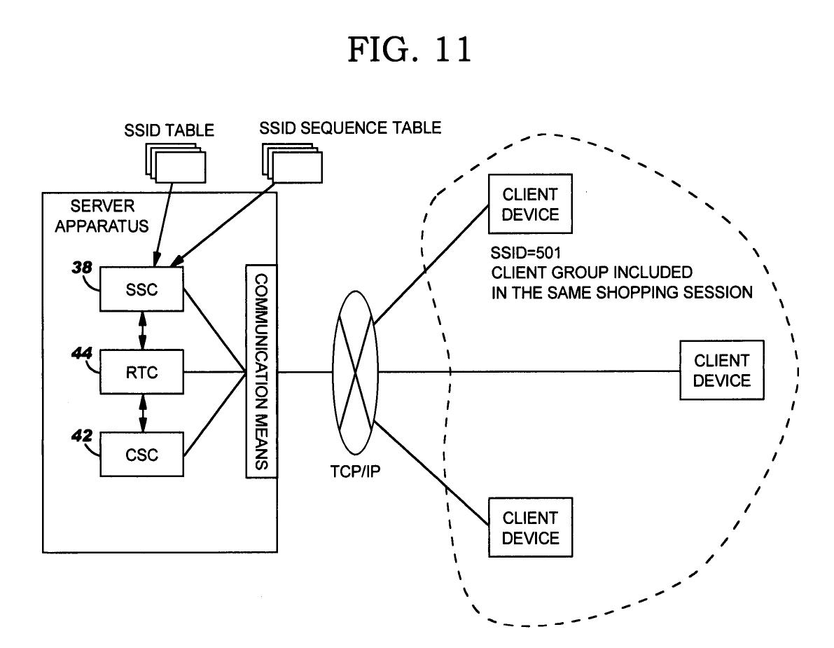

FIG. 11 shows the RTC 44 configured in the server apparatus. The RTC 44 inquires, of the SSC 38, client identification values formed by the SSC 38 and included in a client group in which a dedicated URL address is shared, and acquires the client identification values from the SSID sequence tables. The RTC 44 makes an inquiry to the CSC 42 about the sharing status of the web page regarding collaboration among the client devices. Then, the RTC 44 determines whether or not real time communications are possible based on a response from the CSC 42. The RTC 44 specifies the client devices sharing the web page, and enables the applicable client devices to communicate by use of chat software included by the RTC 44.

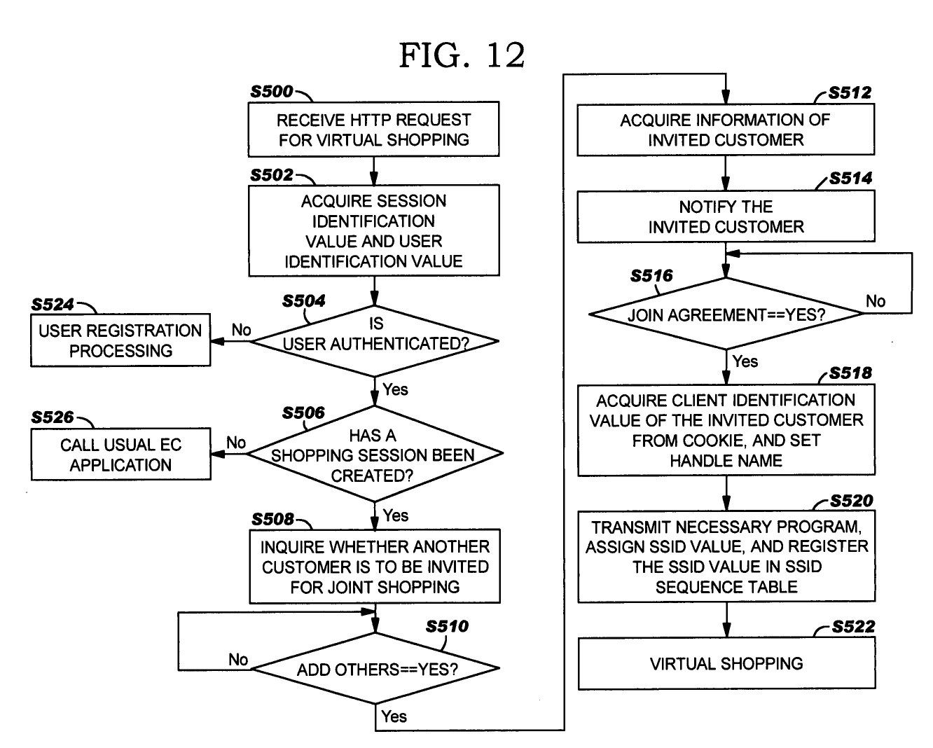

FIG. 12 shows processing to be executed to provide collaboration for the virtual shopping system. First, in Step S500, the server apparatus receives an HTTP request for virtual shopping from the customer through the client device. In Step S502, the server apparatus acquires the session identification value and the user identification value (user ID, password and the like) from data in the received HTTP request such as a cookie.

In Step S504, the server apparatus determines user authentication. When the user is already authenticated, processing proceeds to Step S506, where a determination is made as to whether or not a shopping session has been created. When the shopping session has not yet been created, i.e., “no” in Step S506, processing proceeds to Step S526, where the customer is allowed to establish a shopping session and to execute a conventional EC application. Otherwise, i.e., “yes” in Step S506, the processing proceeds to Step S508, where an inquiry is made as to whether another customer is to be invited to join the shopping session. When another customer is to be invited, i.e., “yes” in Step S510, the server apparatus transmits, to the client device, a display prompting entry of information about the invitation. In Step S510, the server apparatus is on standby for receiving a message, for example a message including a command of “?add others==yes” from the client device. When the customer receives an HTTP request desiring invitations through the client device (i.e., yes in Step S510), the processing proceeds to Step S512, where the server apparatus acquires, responsive to the received HTTP request, information such as, for example, an electronic mail address of the customer to be invited, and temporarily stores the information in the memory.

Thereafter, in Step S514, the server apparatus notifies the invited customer by transmitting electronic mail or the like to the invited customer. In Step S516, the server apparatus determines whether or not the customer accepts the invitation by monitoring an HTTP response from the invited customer, for example, “?Joinagreement==yes.” When the response indicates that the other customer accepts the invitation, i.e., “yes” in Step S516, the processing proceeds to Step S518, where client identification information is acquired, and a handle is set. Part of the address of the electronic mail before its domain identification code may be used as the handle name of the invited customer, for example, “Hiro.” Then, the handle name and the client identification value such as an IP address of the other customer are stored in association with each other by use of cookie data or the like. Optionally, the handle name may be set by the invited customer.

In Step S520, the server apparatus transmits the necessary programs, assigns a value of the already acquired group session, for example “501,” to the server apparatus itself and the invited customer, creates an SSID table and an SSID sequence table, and creates http://host_path/SSID_{—}501/default.jsp as a dedicated URL address. The server apparatus individually controls the PNC, CSC, and the RTC, and allows them to execute the virtual shopping.

A customer group list for the joint session can be formed ahead of time by the customers, and can be registered in the server apparatus. In this case, a predetermined customer designates another customer who the predetermined customer desires to invite with reference to the list at the point in time when inviting the other customer in Step S514, thus initiating the joint shopping.

When the authentication is not yet performed in Step S504, the server apparatus executes a known authentication processing, and the processing proceeds to Step S524 for completing registration and authentication.

When the customer creates the shopping session through the client device, the customer receives a command such as http://hostname/ECSystem/Login?USERID=MY_useride&password=PASSWORD&creat eShoppingSession=true, and retrieves or newly creates the userID and the password. Meanwhile, the server apparatus transmits the HTTP request of http://hostnameECSystem/CreateShoppingSession to an application server or an application function unit, and creates a new session.

The HTTP request for inviting other customers can be given as, for example, http://hostname/ECSystem/Invitation?Invitees=Hiro, Saburo, Shiro. In this case, the server apparatus has previously received, from the customer who makes the invitation, the data needed for the invitation notices, and the server apparatus is configured such that the inviting customer can make the invitation by designating only the designated handle names. Note that the information about the other customers, once designated by the predetermined customer, is stored by the server apparatus, thus making it possible to create the virtual shopping session using just the handle names.

An HTTP request for attendance to the group session may be sent as http://hostname/ECSystem/Join?shoppingSession=501 to the server apparatus. Upon receiving this HTTP request, the server apparatus sets the received HTTP request as http://host/app_path/SSID_{—}501/default.jsp by use of a group session identification value added to the dedicated URL address, thus making it possible to integrate the HTTP requests from the client devices, such as individual session identification values SESSION A and SESSION B, which are included in the SSID table, with reference to the SSID table.

The server apparatus may execute the processing shown in FIG. 12. First, an HTTP request is received from a predetermined user, and the server apparatus acquires a browser session from a cookie. After the server apparatus authenticates the user, the server apparatus is allowed to create the shopping session, and thus is enabled to access the dedicated URL address. Thereafter, ownership of the initiative of web page operation is set, synchronization of the web page and the EC processing function are executed, and an updated cookie is sent in HTTP responses to the client devices. Note that the setting of ownership of the initiative of web page operation can be performed by the initiative transfer means 28 included in the page navigation means 22 of the client device, as will be described later.

In the client devices, this function can be changed in such a manner that, for example, an HTTP request such as http://hostname/ECSystem/SSID_A/s_session.setLead?=(Jiro) is transmitted from a predetermined client device to the server apparatus by use of a button on the web page, and a script such as “s_session.setLead?=( )” or an applet is activated in response to use of the button. The server apparatus which has received this request retrieves an identifier of the individual session with reference to the corresponding SSID. Thereafter, the initiative flag of the corresponding individual session is changed with reference to the SSID sequence table, and thus the setting of the initiative is executed based on the request.

An embodiment of the virtual shopping system realized by the collaboration control of the present invention by use of the web page displayed on the client devices will now be described. Suppose, for example, that a first customer resides in New York and that a second customer resides in Toronto. Here, it is assumed that the first customer desires to do the virtual shopping with the remote friend and accesses the server apparatus by use of the session identification value SESSION A as his own value. The server apparatus which has received the HTTP request from the first customer inviting the second customer notifies the second customer of the invitation, and allows the second customer to display a login screen.

In this case, when the second user does not have the required virtual machine, the required programs may be sent as Java Applets from the server apparatus to the second client device, and the second client device may thus be configured as the needed virtual machine. Here, the invited second customer transmits, to the server apparatus, the HTTP request indicating that the second customer will accept the invitation, and thus the dedicated URL address corresponding to each SSID is created, and the sharing of the web page is started.

When the first customer changes the web page, the PNID is created immediately, and the displayed web page is stored as the snapshot data in the server apparatus together with the PNID, and stored in the page management table. In the second client, the synchronization control means is already configured. Accordingly, the second client monitors the page management table of the dedicated URL address. When the server apparatus registers a snapshot of a new web page as new PNIDcurrent, the second client device compares the PNIDcurrent with its own PNID. When the PNIDcurrent is different from its PNID, the second client device transmits, to the server apparatus, the HTTP request for the applicable snapshot, and acquires the web page designated by the PNIDcurrent. Similar processing is executed every time the first customer changes the web page.

Moreover, the transfer of ownership of the initiative of web page operation can be performed by clicking a button displayed on the web page by the second client device. When a button “leave page to your friend” is clicked, for example, the client device transmits the HTTP request for transferring ownership of the initiative of web page operation to the server apparatus. The usual web page data rather than the snapshot data is transmitted as the HTML file to the client devices, and the initiative of the web page operation is transferred from the first customer to the second customer. Moreover, from then on, the snapshot data is sent, in synchronization, to the customer who has relinquished ownership of the initiative of web page operation.

When the customer using the client device which has received ownership of the initiative returns the initiative to the other customer, that is, the customer who has originally owned the initiative, for example, by the RTC 44 or according to his own desire, a notice thereof is transmitted to the other by the RTC 44, and the other has the initiative again.

For example, when the first customer purchases a predetermined item, the customer selects the item displayed on the web page, and executes processing such as “put in cart.” In this case, although the shopping session is shared, the shopping sessions of the respective client devices are uniquely made with reference to the SSID table; accordingly, disadvantages such as, for example, passing the bill for the purchase to the wrong customer by mistake can be prevented.

Moreover, in another embodiment of the present invention, a charge destination is changed to the other customer sharing the web page, thus enabling a plurality of customers residing remotely from one another to “coach” each other. In this case, the communications and agreements among the customers can be made by the RTC 44, and the data regarding the purchased item can be shared as a web page by referring to the session identifiers of the other customers included in the same shopping session.

All of the above-described functions of the present invention can be configured as software blocks allowing the computer device to execute a computer-executable program. The computer-executable program of the present invention can be described in a variety of programming languages such as, for example, C language, C++ language, Java, Java Applet, Java Script, Java Beans, Servlet, and the like. Moreover, the present invention has been described on the assumption that the client device is allowed to configure the virtual machine. However, it is also possible that the server apparatus can be allowed to own all of the similar functions and that the functions can be configured as a cgi process.

The computer-executable programs of the present invention can be stored in a variety of computer-readable storage media such as flexible disks, hard disks, CD-ROMs, MOs, DVDs, and the like, and then be distributed. Moreover, the programs can be distributed by transmitting them through the network.

Although the preferred embodiments of the present invention have been described in detail, it should be understood that various changes, substitutions, and alternations can be made therein without departing from spirit and scope of the invention as defined by the appended claims.

1. A server suitable for use in a collaboration system employing a communication network, said server comprising:
a group session control unit for creating a group session by integrating a plurality of individual sessions and for passing a command to an application execution unit; and
a page navigation control unit for providing a web page common to each of the individual sessions.

2. The server according to claim 1, further comprising:
a synchronization control unit for notifying each of individual session destinations of a shared status of the web page; and
a mutual communication control unit allowing a plurality of the individual session destinations to exchange messages.

3. The server according to claim 1, further comprising initiative switching means for switching ownership of initiative of web page operation.

4. The server according to claim 1, wherein the page navigation control unit includes a page sharing processing unit for creating data by compiling the web page and an identification value corresponding to the data in response to display of a new web page and for storing the data and the identification value in association with each other.

5. A client device suitable for use in a collaboration system employing a communication network, said client device comprising:
browser means for displaying data received through the network;
page navigation means for generating a request transmitted over the network for changing ownership of initiative of operation of a web page to be displayed among a plurality of client devices;
synchronization control means for synchronizing display of a web page shared by the plurality of client devices; and
communication means for communicating over the network with other client devices among the plurality of client devices.

6. The client device according to claim 5, wherein the synchronization control means issues a request for making an inquiry about an identification value of already compiled data of the web page through the network in response to ownership status of initiative of operation of the web page.

7. The client device according to claim 5, wherein the client device executes virtual shopping with collaboration.

8. A computer-executable program for enabling a computer device to function as a server apparatus suitable for use in a collaboration system employing a communication network, said program allowing the computer device to execute:
a step of forming a group session control unit for creating a group session by integrating a plurality of individual sessions and for passing a command to an application execution unit; and
a step of forming a page navigation control unit for providing a web page common to each of the individual sessions.

9. The program according to claim 8, wherein the program allows the computer device to further execute:
a step of forming a synchronization control unit for notifying each of individual session destinations of a shared status of the web page; and
a step of forming a mutual communication control unit for allowing a plurality of the individual session destinations to exchange messages.

10. The program according to claim 8, wherein the program allows the group session control unit to execute a step of switching ownership of initiative of web page operation.

11. The program according to claim 8, wherein the program allows the page navigation control unit to execute a step of creating data created by compiling the web page and an identification value corresponding to the data when a new web page is displayed and of storing the data and the identification value in a storage device in association with each other.

12. A computer-executable program for allowing a computer device to function as a client device suitable for use in a collaboration system employing a communication network, said program allowing the computer device to execute:
a step of communicating a request for changing ownership of initiative of operation of a web page to be displayed among a plurality of client devices;
a step of allowing the plurality of client devices to share the web page; and
a step of allowing the client device to display a message for other client devices among the plurality of client devices.

13. The program according to claim 12, wherein the program allows the client device to execute virtual shopping in which the client devices collaborate.

14. A collaboration system for allowing client devices to collaborate through a network, the system comprising:
a plurality of the client devices connected to the network; and a server apparatus for receiving requests from the client devices, responding to the client devices, and providing a collaboration environment common to the plurality of client devices, wherein the server apparatus includes means for providing a group session formed by integrating communication sessions among the plurality of client devices, and means for synchronizing the client devices in the collaboration environment; and further wherein each of the client device includes means for synchronizing according to a web page commonly displayed among the plurality of client devices.

15. The collaboration system according to claim 14, wherein the collaboration system is a virtual shopping system.
